(19) United States
(12) Patent Application Publication
(10) Pub. No.: US 2009/0197522 A1
(43) Pub. Date: Aug. 6, 2009

(54) THERMALLY-ACTUATED CARTRIDGE AND FIRE DAMPER

(76) Inventor: Richard Perrin, Kent (GB)

Correspondence Address: DICKSTEIN SHAPIRO LLP, 1825 EYE STREET NW, Washington, DC, 20006-5403, US

(21) Appl. No.: 12/424,223

(22) Filed: Apr. 15, 2009

Related U.S. Application Data
(62) Division of application No. 10/525,251, filed on Aug. 5, 2005, now Pat. No. 7,530,891.

(30) Foreign Application Priority Data
Aug. 19, 2002 (GB) 0219297.9

(51) Int. Cl. A62C 2/12; A62C 2/24

(52) U.S. Cl. 454/369; 137/79

(57) ABSTRACT

A thermally-actuated cartridge (21) has a center pin (24) which is arranged to protrude through the rear of a cartridge holder (23) when the cartridge assembly (21) is not set, so that it is apparent that the cartridge assembly (21) is not set. In a fire damper for an airflow duct, the cartridge assembly (21) is used as a detent to hold a damper flap (7) open. There is a particularly convenient way of mounting the detent arrangement by having a U-shaped member (9) which carries a limb (15) acting as a backing piece for a retention quadrant (7) and a sprung bracket (16) which are squeezed together by the cartridge assembly (21). The U-shaped member (9) is mounted by a means of a limb extension (10) which slots over the damper flap axle (5) and is held by a rivet (13) in the correct orientation, the cartridge assembly (21) being screwed through a threaded bore formed by upsetting or swaging a limb (14) of the U-member (9) through a hole in the extension (10).

### BACKGROUND OF THE INVENTION

The present invention relates generally to thermally-actuated cartridges for fire dampers for airflow ducts, but also relates more generally to any thermally-actuated mechanism and any damper for airflow ducts.

WO 02/43810 and EP 0300992 disclose the use of thermal cartridges for closing the damper element of a fire damper in an airflow duct. There can be problems with the cartridge if it is wrongly installed. For instance, if it is screwed in too tightly, the solder (or other heat-softenable or meltable material) can rupture, but there is no indication that this has occurred so that if there is a fire, the damper element does not close.

The installation of a member for carrying the cartridge and arranging for the retention of the damper element can give significant difficulty.

### THE INVENTION

The present invention provides a thermally-actuated cartridge as set forth in Claim 1 or 13, a thermally-actuated mechanism as set forth in Claim 14 and a damper as set forth in Claim 18, 31 or 42, as well as the airflow insulation of Claim 43. The remaining Claims set forth preferred or optional features of the invention.

In Claim 1, the movable member protrudes through the opening when the cartridge is triggered. This has the advantage of indicating externally that an excessive temperature has been reached. However, there is also the advantage that if the cartridge is say screwed in too hard, and the solder ruptured, it is apparent from outside that the mechanism would be inoperative. In effect, the invention provides fail-safe operation. There is also the advantage that the protruding end portion of the movable member can be arranged to actuate a microswitch, which can give a warning signal.

Preferably the arrangement is such that when the cartridge or mechanism is set, the movable member does not protrude at all or substantially through the opening, the end of the movable member preferably being flush with the opening. In this way, a protruding end gives a clear signal that the cartridge or mechanism is not set. However, if the end of the movable member protrudes when the cartridge or mechanism is set, the end portion can be profiled or marked so that its movement is apparent.

The difficulty of installation can be avoided using the damper of Claim 31. The U-shaped member is easily installed in that the second limb can be engaged over the damper element axle to locate the U-shaped member and then the U-shaped member firmly fixed using the securing means to secure the second limb to the inner circumferential wall of the ducting.

### PREFERRED EMBODIMENT

The invention will be further described, by way of example, with reference to the accompanying drawings, in which:

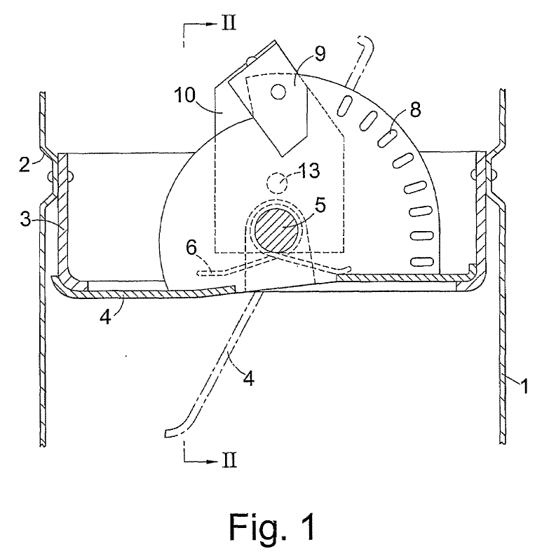

FIG. 1 is a part longitudinal section through a section of airflow ducting which forms a fire damper;

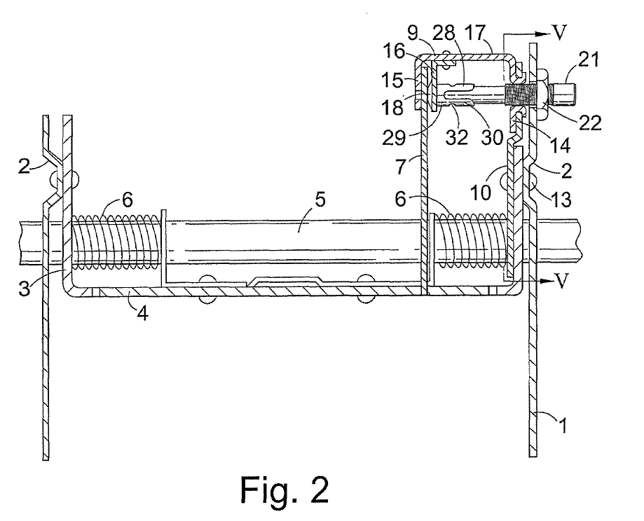

FIG. 2 is a part longitudinal section along the plane II-II in FIG. 1;

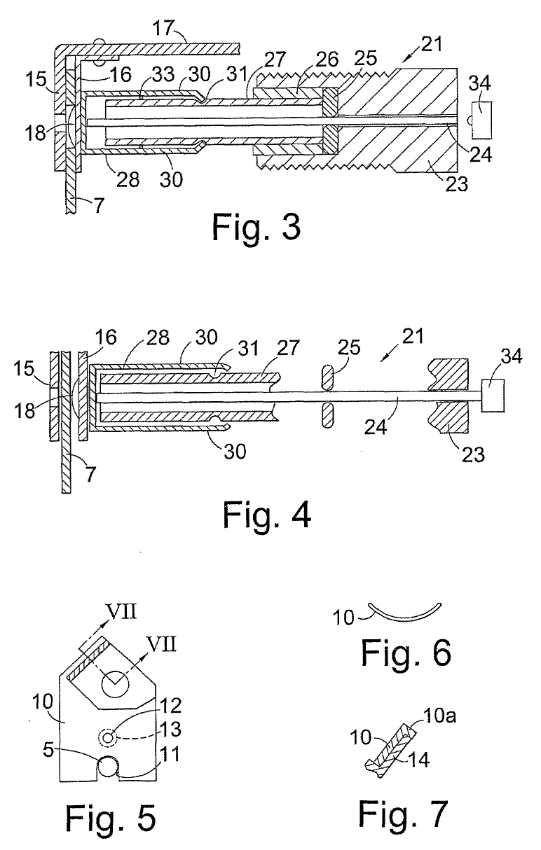

FIG. 3 is an enlarged part-longitudinal section through the thermal cartridge shown in FIG. 2, in the set configuration;

FIG. 4 corresponds to FIG. 3, but shows the cartridge when it has triggered;

FIG. 5 shows the right-hand end of the U-shaped member (as seen looking in FIG. 2), in section along the plane V-V indicated in FIG. 2;

FIG. 6 is a view of the end limb of FIG. 5 looking in the direction of the arrow VI in FIG. 5; and

FIG. 7 is a section of the end limb taken along the line VII-VII in FIG. 5.

FIGS. 1 and 2 show ducting 1 for for instance an air-conditioning installation. A damper is provided by swaging the ducting 1 inwards at 2, riveting a cylindrical rim 3 to the swaged-in part 2 and pivoting a damper element or flap 4 on a transverse axle 5. In the closed position shown in full lines in FIG. 1, the periphery of the flap 4 bears against the rim 3, effectively to close the duct. The fully open position of the flap 4 is indicated in chain-dotted lines in FIG. 2. At the sides, the flap 4 is suitably cut away, generally as illustrated in WO 02/43810. Two helical springs 6 bias the flap 4 into its closed position.

A generally sector-shaped retention member or quadrant 7 is held in a slot in the flap 4 and secured by the axle 5 which passes through a hole in the quadrant 7 so that the quadrant 7 is fixed relative to the flap 4. The quadrant 7 has a series of cut-outs or notches 8 adjacent its periphery.

A U-shaped support member 9 is mounted in position in the following manner. The U-shaped support member 9 has at right angles thereto a profiled limb extension 10 which has a notch 11 in its lower end (see FIG. 5) which locates over the axle 5 and has a bore 12 by which the extension 10 is secured to the inner circumference of the ducting 1 at the swaging 2 by securing means in the form of a rivet 13 (see FIG. 2). The notch 5 ensures that the limb extension 10 is correctly aligned. The limb 14 of the support member 9 which is nearer the wall of the ducting 1 is swaged onto the end of the extension 10, as shown in FIG. 2, thus fixing the limb extension 10 to the support member 9. The swaging is taken through a circular bore in the limb extension 10, and is tapped with a female thread. As can be seen in FIG. 2, the extension 2 is suitably profiled. The part adjacent the axle 5 is curved to mate properly with the rim 3 (see FIG. 6) and there is a small side flange 10a to engage the edge of the limb 14 (see FIG. 7).

The other limb 15 of the support member 9 is internally of the quadrant 7. Externally of the quadrant 7, a sprung L-bracket 16 is riveted to the base 17 of the support member 9. The bracket 16 has pressed in it a dimple 18 which is roughly the same size as the cut-outs in the quadrant 7 and which, in the set position of the damper, engages in a cut-out 8.

A cartridge assembly 21 is passed through a hole in the ducting 1 and screwed into the tapped swaging of the limb 14, being held in place by a lock-nut 22. Though not shown, the lock-nut 22 is screwed up until the wall of the ducting 1 firmly abuts the swaging of the limb 14, the wall deforming to permit this. The cartridge assembly 21 is formed of a body member or cartridge holder 23 (see FIGS. 3 and 4) having a central bore accommodating a movable member in the form of a rod or pin 24 and a counter bore accommodating an O-ring 25 and a plastic sleeve 26. The O-ring 25 applies friction to the pin 24 and holds it in the assembly 21 (as an alternative, or in addition, ears can be formed on the pin 24 by swaging, to the left of the O-ring 25, as looking in FIG. 2). The end of the pin 24 does not protrude substantially through the external opening in the holder 23, and the end of the pin 24 is preferably flush with the end face of the holder 23. The cartridge proper, in the form of a cylindrical casing 27, is pressed into and held by the sleeve 26. On the end of the casing 27 there is a detent body or claw holder 28 which has an actuating member or head in the form of a short end cap 29 (see FIG. 2) carrying two elongate detents or claws 30. The claws have inturned ends which engage in an annular groove 31 in the casing 27. The claws 30 have circular openings 32 near their roots, to make them less rigid, and adjacent each opening 32 a heat-softenable or meltable (fusible) material in the form of solder 33 is applied so that it adheres both to the claws 30 and to the outside of the casing 27. As the force on the ends of the claws is always in a radial direction before the solder 33 melts, the solder 33 is under tension.

In order to set the fire damper, the flap 4 is opened using a key and is held at a suitable inclination. The cartridge assembly 21 is then screwed in and the flap 4 positioned so that the dimple 18 engages in a cut-out 8. The end cap 29 should abut firmly against the spring bracket 16, which acts as an engaging member, pressing the quadrant 7 against the limb 15, which then acts as a backing piece, thereby securing the quadrant 7 and holding the flap 4 in an open position. The lock nut 22 is applied.

If the temperature rises excessively, the solder 33 melts. The springs 6 are sufficiently strong to cam the dimple 18 out of the cut-out 8, pushing the claw holder 28 to the right as shown in FIG. 3 and camming the ends of the claws 30 out of the groove 31 (in a radial direction) so that the configuration is as shown in FIG. 4. The movement of the claw holder 28 causes the pin 24 to move to the right (as shown in FIG. 4) and its end now protrudes from the cartridge holder 23. This indicates that the cartridge assembly 21 is no longer set. If desired, a microswitch 34 can be mounted so as to be actuated by the pin 24, to give a signal.

In a variation of the arrangement, not illustrated, there is no thermal cartridge as such. The O-ring 25 is replaced by a disc and the rod 24 suitably shortened and the casing 27 is arranged so as to abut directly on the spring bracket 16. The rod 24 is connected to a solenoid which, when energised, applies a constant force on the rod 24, urging it to the left in FIG. 3 and holding the flap 4 open. For adjustment or on an excessive temperature rise, the solenoid is de-energised, the rod 24 moves to the right and the flap 4 is freed.

In a further variation, not illustrated, where the thermal cartridge is not wanted, the same basic arrangement can be used. It would be possible to use a dummy cartridge with equivalent proportions, but in practice, the cartridge is omitted and a longer pin 24 is used. The left-hand end of the pin engages in the dimple 18 and the right-hand end of the pin 24 can be acted on by say a solenoid. In this case, as the right-hand end of the pin 24 will protrude all the time, it can have steps formed in it or can be marked with say red paint to give an indication whether the arrangement is set or not. If as in yet a further variation, the spring bracket 16 is omitted, the pin 24 can act both as the moving member and as the engaging member and engage in one of the cut-outs 8.

### EXAMPLE

In one preferred example, the following components were used:
Spring bracket 16—spring quality stainless steel;
U-member 9—plated mild steel;
Casing 27—7 mm diameter, brass;
Claw holder 28—brass;
Cartridge holder 23—mild steel, plated;
O-ring 25—neoprene;
Plastic sleeve 26—PVC,
Solder—melting point preferably 72° C., but according to installation requirements, up to 102° C.;
Centre bore in cartridge holder 23—nominal 4 mm;
Pin 24—nominal 4 mm, stainless steel;
Movement of claw holder 28—2 mm;
Diameter of cartridge holder 23—12.5 mm;
Depth of swaging 2—2.5 mm.

Unless the context clearly requires otherwise, throughout the description and the Claims, the words “comprise” and the like are used in an inclusive as opposed to an exclusive or exhaustive sense, that is to say, in the sense of “include, but not limited to”.

The present invention has been described above purely by way of example, and modifications can be made within the spirit of the invention. The invention also consists in any individual features described or implicit herein or shown or implicit in the drawings or any combination of any such features or any generalisation of any such features or combination. Each feature disclosed in the specification, including the Claims, abstract and drawings, may be replaced by alternative features serving the same, equivalent or similar purposes, unless expressly stated otherwise.

1-43. (canceled)

44. A damper for an air flow duct comprising:
ducting;
a rotary damper element carried on an axle in the ducting and movable between a closed position and an open position;
biasing means biasing the damper element into its closed position; and
retention means retaining the damper element in an open position;
the retention means comprising:
an actuating member;
a retention member which is fixed relative to the damper element and which can be secured by the action of the actuating member to retain the damper element in an open position, which securing can be released by movement of the actuating member to release the damper element so that the damper element is moved by the biasing means into its closed position; and
a support member fixed to the circumferential wall of the ducting, the support member having a limb on the opposite side of the retention member to the actuating member, the limb acting as a backing piece to support at least part of the retention member against a force exerted by the actuating member on the retention member to hold the rotary damper element in an open position,
wherein the retention means comprises an indexing arrangement allowing the rotary damper element to be held in an open position at one of a plurality of inclinations, the indexing arrangement comprising a plurality of indexing positions on the retention member with which the actuating member can engage.

45. A damper as claimed in claim 44, wherein the indexing positions comprise a plurality of cut-outs or notches adjacent the periphery of the retention member.

46. A damper as claimed in claim 44, the support member having a further limb in the form of a sprung piece on the same side of the retention member as the actuating member, which sprung piece is pressed against the retention member by the actuating member when the damper element is retained in an open position.

47. A damper as claimed in claim 46, the sprung piece having a dimple to engage one of said indexing positions when the sprung piece is abutted by the actuating member.

48. A damper as claimed in claim 47, wherein the dimple is substantially the same size as said indexing positions.

49. A damper as claimed in claim 44, wherein the support member has a base and a further limb, at an angle to the base, which further limb is adjacent the inner circumferential wall of the ducting and has a notch on its open end passing over the damper element axle, the damper further comprising securing means securing the further limb to the inner circumferential wall of the ducting at a position between the axle and the base of the support member.

50. A damper as claimed in claim 49, wherein the further limb adjacent the inner circumferential wall of the ducting is formed as an initially separate extension piece which is secured to the remainder of the support member.

51. A damper as claimed in claim 44, wherein the retention means comprise a body member which is fixed to an opening in the circumferential wall of the ducting and which carries the actuating member.

52. A damper as claimed in claim 51, wherein there is a tapped hole through said further limb adjacent the base of the support member, into which hole is screwed the body member.

53. A damper as claimed in claim 44, wherein the actuating member forms part of a thermally-actuated assembly for releasing the retention member if a certain temperature is reached.

54. A damper as claimed in claim 44, and including means externally of the ducting for acting on the actuating member to release the retention member.

55. A damper, substantially as herein described with reference to the accompanying drawings.
